(19) United States
(12) Patent Application Publication
(10) Pub. No.: US 2002/0197063 A1
(43) Pub. Date: Dec. 26, 2002

(54) Method and apparatus for recording and searching an audio/video signal

(75) Inventor: Chang-Hyung Cho, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/024,716

(22) Filed: Dec. 21, 2001

(30) Foreign Application Priority Data
Jun. 26, 2001 (KR) 2001-36582

(51) Int. Cl. H04N 5/91

(52) U.S. Cl. 386/94

(57) ABSTRACT

A method and apparatus for extracting a category item from an audio/video (A/V) signal to be recorded on a storage medium, storing the extracted category item, and searching for the A/V signal using the category item are provided. The method of recording an A/V signal includes seizing the category of the A/V signal and selecting a category item for the A/V signal, storing category information about the A/V signal, the category information including the category item, and recording the A/V signal to a storage medium. Accordingly, an A/V signal stored in a storage medium is searched for by a category so that the A/V signal can be easily searched for. Since the compression ratio of each A/V signal is controlled depending on its category when the A/V signal is recorded to a storage medium, the storage capacity of the storage medium is efficiently managed.

### CROSS-REFERENCE TO RELATED APPLICATIONS

This application claims the benefit of Korean Patent Application No. 2001-36582, filed Jun. 26, 2001, in the Korean Industrial Property Office, the disclosure of which is incorporated herein by reference.

### BACKGROUND OF THE INVENTION

1. Field of the Invention

The present invention relates to a method and apparatus for recording and searching an audio/video (A/V) signal, and more particularly, to a method and apparatus for easily searching an A/V signal recorded on a storage medium such as a hard disc and efficiently managing a storage capacity.

2. Description of the Related Art

Generally, types of apparatuses for recording an input A/V signal on a storage medium such as a hard disc and searching an A/V signal recorded to a storage medium are personal video recorders (PVRs) provided with a time-shift function and a search function, and digital video recorders (DVRs).

However, these apparatuses are designed to record an input A/V signal on a storage medium in the form of a file. Accordingly, it takes a long time for the apparatuses to search the A/V signal when a large amount of the A/V signal is recorded on the storage medium.

Moreover, when recording the input A/V signal on the storage medium, the apparatuses compress the A/V signal to efficiently manage a storage capacity of the storage medium. However, the apparatuses compress the A/V signal at a fixed compression ratio regardless of the type of A/V signal, which results in the apparatuses inefficiently managing the storage capacity of the storage medium.

### SUMMARY OF THE INVENTION

Accordingly, it is an object of the present invention to provide a method and apparatus for extracting a category item from an audio/video (A/V) signal to be recorded to a storage medium, storing the extracted category item, and searching for the A/V signal using the category item.

Objects of the present invention are also achieved by providing a method and apparatus for compressing an A/V signal at a compression ratio determined based on the category item of the A/V signal when recording the A/V signal to a storage medium.

Additional objects and advantages of the invention will be set forth in part in the description which follows, and, in part, will be obvious from the description, or may learned by practice of the invention.

The foregoing and other objects of the present invention are achieved by providing a method of recording an A/V signal. The method includes selecting a category item for the A/V signal and storing category information about the A/V signal. The category information includes the category item. The method also includes recording the A/V signal to a storage medium.

The category item selecting includes extracting feature information in which a category of the A/V signal is seized, comparing the feature information with a predetermined category list and selecting the category item for the A/V signal based on a result of the comparison.

The A/V signal recording includes determining a compression ratio for the A/V signal according to the category item selected for the A/V signal and recording the A/V signal, which is compressed at the compression ratio, to the storage medium.

The category item is selected by a user. The method of recording the A/V signal further includes allowing a user to add a category item.

The foregoing and other objects of the present invention are also achieved by providing a method of searching a storage medium for an A/V signal. The method includes, when a search for the A/V signal is requested, displaying a category list of one or more A/V signals stored in the storage medium, and when a category item to be searched for is selected from the displayed category list, displaying a list of A/V signals falling under the category item. The method also includes, when the A/V signal is selected from the list of A/V signals falling under the category item, reading the selected A/V signal from the storage medium and displaying the selected A/V signal.

The foregoing and other objects of the present invention are also achieved by providing an apparatus for recording an A/V signal, including a first storage medium storing one or more A/V signals, a demultiplexing processor demultiplexing an input A/V signal, extracting feature information in which the category of the A/V signal is seized, and transmitting the A/V signal to the first storage medium. The apparatus includes a controller selecting and storing a category item for the input A/V signal based on the feature information provided from the demultiplexing processor, and controlling the demultiplexing processor to record the input A/V signal to the first storage medium. The apparatus also includes a second storage medium storing category information including the category item.

The controller determines a compression ratio for the input A/V signal according to the category item and provides information on the determined compression ratio to the demultiplexing processor. The demultiplexing processor compresses the input A/V signal at the compression ratio and transmits the compressed A/V signal to the first storage medium.

The foregoing and other objects of the present invention are also achieved by providing an apparatus for searching a first storage medium for an A/V signal. The apparatus includes an information input unit inputting information pertaining to a request of searching for the A/V signal stored in the first storage medium, a second storage medium storing category information including a category list of one or more A/V signals stored in the first storage medium, and a display unit displaying the category list. The apparatus also includes a controller reading the category list from the second storage medium, controlling the category list to be displayed on the display unit when the search request information is received from the information input unit, and when the A/V signal falling under a particular category item is selected from the displayed category list through the information input unit, reading the selected A/V signal from the first storage medium.

### BRIEF DESCRIPTION OF THE DRAWINGS

These and other objects and advantages of the invention will become apparent and more appreciated from the following description of the preferred embodiments, taken in conjunction with accompanying drawings of which:

FIG. 1 is a block diagram of an audio/video (A/V) signal recording and searching apparatus, according to an embodiment of the present invention;

FIG. 2 is an example of an image provided when an A/V signal is searched for, according to an embodiment of the present invention;

FIG. 3 is a flowchart of a method of recording an A/V signal, according to an embodiment of the present invention; and

FIG. 4 is a flowchart of a method of searching for an A/V signal, according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals to like elements throughout.

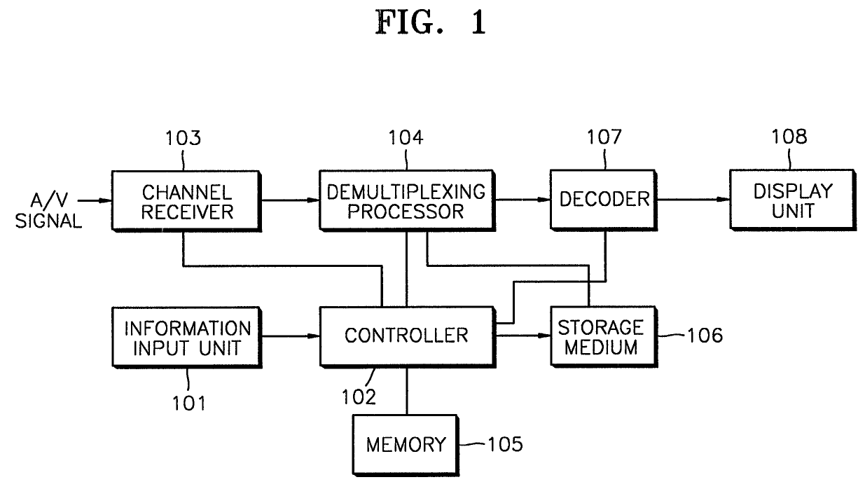

FIG. 1 is a block diagram of an audio/video (A/V) signal recording and searching apparatus, according to an embodiment of the present invention.

Referring now to FIG. 1, an audio/video (A/V) signal recording and searching apparatus includes an information input unit 101, a controller 102, a channel receiver 103, a demultiplexing processor 104, a memory 105, a storage medium 106, a decoder 107, and a display unit 108.

The information input unit 101 allows information necessary to operate the A/V signal recording and searching apparatus of the present invention to be input to the apparatus, and is recognized as a remote controller or a key input unit on the front panel of the apparatus. Accordingly, a user inputs receiving channel information of an A/V signal to be stored or recorded on the storage medium 106, search request information, and selection information of an A/V signal to be searched for, through the information input unit 101. For example, the user inputs information in which a particular category of the A/V signal to be stored is selected or adds a category item using the information input unit 101.

The controller 102 controls the channel receiver 103 to receive the A/V signal through a corresponding channel when channel information is received through the information input unit 101. Accordingly, the channel receiver 103 converts the received A/V signal into a digital signal. The A/V signal may be a satellite broadcast program, a cable television broadcast program, or an over-the-air broadcast program. The digital signal output from the channel receiver 103 is transmitted to the demultiplexing processor 104.

The demultiplexing processor 104 parses system information (SI) contained in the received A/V signal or additional information not contained in the received A/V signal but received together with the A/V signal. The SI includes extended text table (ETT) information, extended channel name descriptor (ECND) information, and network text table information provided from a Program and System Information Protocol (PSIP) or Out-Of-Band System Information (OOBSI). The SI contains feature information in which a category of the received A/V signal is seized. Similar to the SI, the additional information also contains feature information in which a category of the received A/V signal is seized. The SI is mostly used when the received A/V signal is a digital signal. The additional information is mostly used when the received A/V signal is an analog signal such as an over-the-air broadcast program.

After parsing the SI or additional information, the demultiplexing processor 104 extracts and provides the feature information to the controller 102 and compares the feature information with a predetermined category list to select a category item for the received A/V signal. The category list includes category items selected based on types of A/V signals which are input to the A/V signal recording and searching apparatus. For example, when the A/V signals which are input to the apparatus are categorized into news, drama and documentary, the category list includes category item information about the news, category item information about the drama, and category item information about the documentary.

Once the category item is selected, the controller 102 determines a compression ratio according to the selected category item. For example, when it is estimated from the category item that an amount of movement in the received A/V signal is greater than a reference amount of movement, the controller 102 determines the compression ratio to be lower than a reference compression ratio. In contrast, when it is estimated that the amount of movement in the received A/V signal is less than the reference amount of movement, the controller 102 determines the compression ratio to be higher than the reference compression ratio. The determined compression ratio is thereby, sent to the demultiplexing processor 104.

Here, the controller 102 stores category information including the selected category item in the memory 105. The category information includes the name of the program and the date and time when the program is received. The category information is thereby used for searching for the A/V signal after being recorded to the storage medium 106. Accordingly, the memory 105 stores category information including the category items of all A/V signals recorded to the storage medium 106 so that the category information is read by the controller 102. The category list of the category information is thereby provided for the user. Once an A/V signal to be reproduced is selected from the category list, the controller 102 controls a read mode so that the selected A/V signal is transmitted from the storage medium 106 to the demultiplexing processor 104. At least one A/V signal is stored in the storage medium 106.

In a recording mode, the demultiplexing processor 104 compresses a received A/V signal at a compression ratio provided from the controller 102 and records the received A/V signal to the storage medium 106. In a search mode, the demultiplexing processor 104 reads an A/V signal corresponding to category information provided from the controller 102 from the storage medium 106, and transmits the A/V signal to the decoder 107. In a normal playback mode, the demultiplexing processor 104 transmits a received A/V signal to the decoder 107.

The decoder 107 decodes a received A/V signal to be displayed. A conventional decoding method is used for decoding the received A/V signal.

The display unit 108 displays a received A/V signal, an A/V signal reproduced from the storage medium 106, or information used for searching.

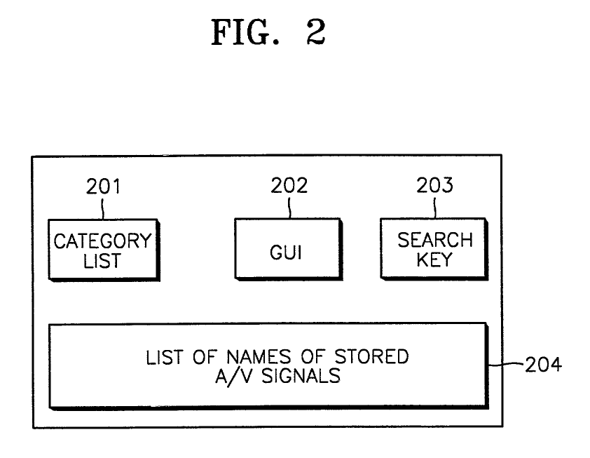

FIG. 2 is an example of an image provided when an A/V signal is searched for, according to an embodiment of the present invention.

Referring now to FIG. 2, information for searching includes a category list 201, a graphic user interface (GUI) 202 through which a desired category item is input, a search key 203, and a list 204 of the names of A/V signals stored in the storage medium 106.

The display unit 108 and the storage medium 106 or the display unit 108 is recognized as an external set-top box. The storage medium 106 is recognized as a hard disc.

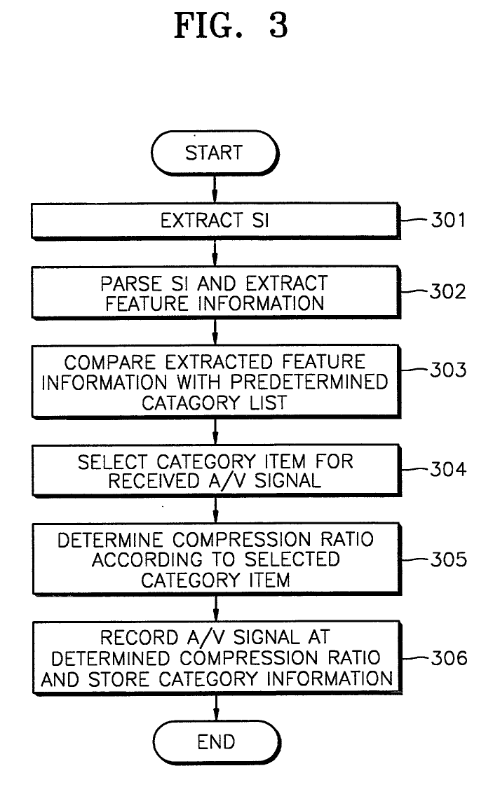

FIG. 3 is a flowchart of a method of recording an A/V signal, according to an embodiment of the present invention.

Referring now to FIG. 3, once an A/V signal is received, Si is extracted from the received A/V signal in operation 301. The SI is described in FIG. 1, above. Thereafter, in operation 302, the extracted SI is parsed, and feature information in which a category of the received A/V signal is seized, is extracted from the SI.

The extracted feature information is compared with a predetermined category list in operation 303. The predetermined category list is the same as that which is described with reference to the controller 102 as described in FIG. 1, above.

In operation 304, a category item for the received A/V signal is selected based on a result of the comparison performed in operation 303. For example, when the received A/V signal is a “dramatic series,” a category item corresponding to the “dramatic series” is selected.

Next, in operation 305, a compression ratio is determined according to the selected category item. A method of determining the compression ratio is described with reference to the controller 102 as described in FIG. 1, above. In operation 306, after the compression ratio is determined, the received A/V signal is compressed at the determined compression ratio, recorded on the storage medium 106, and category information is stored in the memory 105. The category information stored in the memory 105 is described in FIG. 1, above. Once the received A/V signal is completely recorded on the storage medium 106, the entire recording operation ends.

FIG. 3 shows a case in which the category of a received A/V signal is recognized based on SI contained in the received A/V signal. However, the method shown in FIG. 3 may be applied to the case in which the category of a received A/V signal is recognized based on additional information received together with the received A/V signal. For example, instead of SI, additional information may be used in FIG. 3. The additional information is received through the same channel or a different channel than the received A/V signal, as described in FIG. 1, above.

In addition, the category information is stored in the memory 105 as described in FIG. 3, but may be stored in the storage medium together with the corresponding received A/V signal. For example, the category information may be stored at a header area for the received A/V signal in the storage medium 106. The received A/V signal is automatically recorded on the storage medium 106 based on received information as described in FIG. 3. In other words, an A/V signal falling under a category selected by a user is recorded on the storage medium 106. Also, a category item for a received A/V signal may be added by a user when the A/V signal is recorded to the storage medium 106.

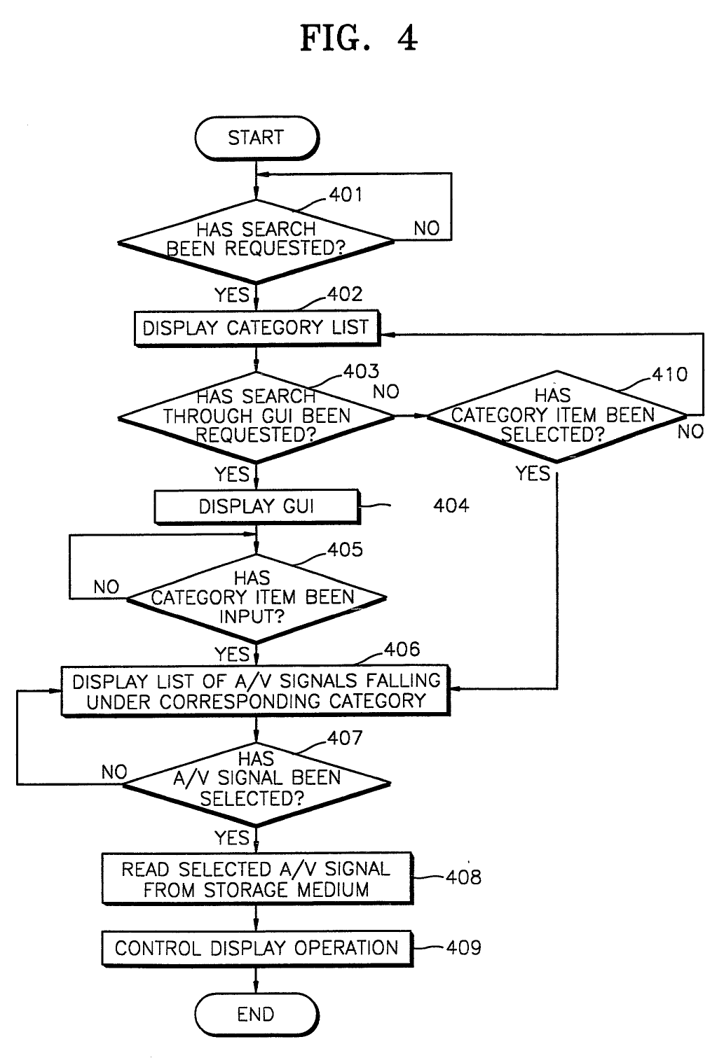

FIG. 4 is a flowchart of a method of searching for an A/V signal, according to an embodiment of the present invention.

Referring now to FIG. 4, a search is requested through the information input unit 101,in operation 401. In operation 402, a category list is displayed. For example, when category information is stored in the memory 105, the controller 102 reads all the category information stored in the memory 105, forms a category list, and transmits the category list to the display unit 108 through the demultiplexing processor 104 and the decoder 107, so that the category list recognized by the user is displayed. The category list 201 is displayed on a portion of a screen, as shown in FIG. 2, but may also be displayed on an entire screen. When category information is stored in the storage medium 106, the controller 102 collects the category information stored at header areas, in areas in which individual A/V signals are stored in the storage medium 106, and forms a category list.

In operation 403, when it is determined that a search through the GUI 202 is requested through the information input unit 101 operation 403, under a state in which the category list is displayed], the controller 102 controls the demultiplexing processor 104 and the decoder 107 so that the GUI 202 having a search function is displayed on the display unit 108, in operation 404. Accordingly, the GUI 202 is displayed on the display unit 108, as shown in FIG. 2, above.

Once a category item to be searched for is input through the GUI 202 displayed on the display unit 108, in operation 405, the controller 102 displays a list of A/V signals falling under the category item, in operation 406. For example, when a category item corresponds to a “dramatic series,” in operation 405, the controller 102 displays a list of all A/V signals falling under the “dramatic series,” in operation 406. Here, the displayed list is information based on category information stored in the memory 105 or the storage medium 106, which is, for example, information composed of the list of the names of stored A/V signals 204, as shown in FIG. 2, above.

Once a user selects an A/V signal to be searched for from the displayed list of A/V signals through the information input unit 101, in operation 407, the controller 102 reads the selected A/V signal from the storage medium 106, in operation 408. In operation 409, the controller 102 controls the read A/V signal to be transmitted to the display unit 108 through the demultiplexing processor 104 and the decoder 107 to thereby display the A/V signal.

Meanwhile, when a search through the GUI is not requested, in operation 403, and the user selects a category item from the category list that is being displayed, in operation 410, the operation goes to operation 406, in which a list of A/V signals falling under the selected category item is displayed as described above.

FIG. 4 shows a method of searching for an A/V signal in which a category item to be searched for is selected from a displayed category list of A/V signals falling under the selected category item, or a category item to be searched for is input through a GUI. However, to search a desired A/V signal, a category item for at least one A/V signal stored in the storage medium 106 and a list of at least one A/V signal falling under the category item may be displayed.

According to the present invention, the category information of an A/V signal is stored when the A/V signal is recorded on a storage medium so that the A/V signal stored in the storage medium is searched for by category. Thus, a user is allowed to easily search for a desired A/V signal even if many A/V signals are stored in the storage medium. In addition, when an input A/V signal is recorded to a storage medium, the A/V signal is compressed at a compression ratio which is determined according to the category of the A/V signal so that the storage capacity of the storage medium is more efficiently managed.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of recording an audio/video (A/V) signal, comprising:
selecting a category item for the A/V signal;
storing category information about the A/V signal, the category information including the category item; and
recording the A/V signal to a storage medium.

2. The method of claim 1, wherein the category information is stored in a memory provided separately from the storage medium.

3. The method of claim 1, wherein the category information is stored in the storage medium together with the A/V signal.

4. The method of claim 1, wherein the category item selecting, comprises:
extracting feature information in which a category of the A/V signal is seized;
comparing the feature information with a predetermined category list; and
selecting the category item for the A/V signal based on a result of the comparison.

5. The method of claim 1, wherein the A/V signal recording comprises:
determining a compression ratio for the A/V signal according to the category item selected for the A/V signal, and recording the A/V signal, which is compressed at the compression ratio, to the storage medium.

6. The method of claim 1, wherein the category item is selected by a user.

7. The method of claim 1, further comprising:
allowing a user to add a category item.

8. A method of searching a storage medium, which stores one or more audio/video (A/V) signals, for one of the A/V signals, comprising:
displaying, when a search for the A/V signal is requested, a category list of the one or more A/V signals stored in the storage medium;
displaying, when a category item to be searched for is selected from the displayed category list, a list of the A/V signals falling under the category item; and
reading, when the A/V signal is selected from the list of A/V signals, the selected A/V signal from the storage medium and displaying the selected A/V signal.

9. A method of searching a storage medium, which stores one or more audio/video (A/V) signals, for one of the A/V signals, comprising:
displaying, when a search for the A/V signal is requested, a category item for at least one of the A/V signals stored in the storage medium and a list of at least one of the A/V signals falling under the category item; and
searching, when the A/V signal to be searched for is selected from the displayed category item and A/V signal list, the storage medium for the selected A/V signal.

10. A method of searching a storage medium, which stores one or more audio/video (A/V) signals, for one of the A/V signals, comprising:
displaying, when a user inputs a category item to be searched for through a graphic user interface, a list of the one or more A/V signals falling under the category item among the one or more A/V signals stored in the storage medium; and
searching, when the A/V signal to be searched for is selected from the displayed list of one or more A/V signals, the storage medium for the selected A/V signal.

11. An apparatus for recording an audio/video (A/V) signal, comprising:
a first storage medium storing one or more A/V signals;
a demultiplexing processor demultiplexing one of the input A/V signals, extracting feature information in which a category of the input A/V signal is seized, and transmitting the input A/V signal to the first storage medium;
a controller selecting and storing a category item for the input A/V signal based on the feature information provided from the demultiplexing processor and controlling the demultiplexing processor to record the input A/V signal to the first storage medium; and
a second storage medium storing category information including the category item.

12. The apparatus of claim 11, wherein the controller determines a compression ratio for the input A/V signal according to the category item and provides information on the determined compression ratio to the demultiplexing processor, and the demultiplexing processor compresses the input A/V signal at the compression ratio and transmits the compressed A/V signal to the first storage medium.

13. An apparatus of claim 11, wherein the feature information extracted by the demultiplexing processor is system information (SI) contained in the input A/V signal, or additional information received together with the input A/V signal.

14. An apparatus of claim 13, wherein the SI comprises extended text table (ETT) information, extended channel name descriptor (ECND) information, and network text table information provided from a Program and System Information Protocol (PSIP) or Out-Of-Band System Information (OOBSI).

15. An apparatus of claim 13, wherein the SI is used when the input A/V signal is a digital signal.

16. An apparatus of claim 13, wherein the additional information is used when the input A/V signal is an analog signal.

17. An apparatus of claim 13, wherein the additional information received together with the input A/V signal, is received through the same channel or a different channel than the input A/V signal.

18. An apparatus for searching a first storage medium, which stores one or more audio/video (A/V) signals, for one of the A/V signals, comprising:
an information input unit inputting information pertaining to a request of searching for the A/V signal stored in the first storage medium;
a second storage medium storing category information including a category list of the one or more A/V signals stored in the first storage medium;
a display unit displaying the category list; and
a controller reading the category list from the second storage medium and controlling the category list to be displayed on the display unit when the search request information is received from the information input unit, and when the A/V signal falling under a particular category item is selected from the displayed category list through the information input unit, reading the selected A/V signal from the first storage medium.

19. An apparatus for recording an audio/video (A/V) signal to a storage medium, comprising:
a selecting unit selecting a category item for the A/V signal;
a storing unit storing category information about the A/V signal, the category information including the category item; and
a recording unit recording the A/V signal to the storage medium.

20. An apparatus according to claim 19, wherein the category information is stored in a memory provided separately from the storage medium.

21. An apparatus according to claim 19, wherein the category information is stored in the storage medium together with the A/V signal.

22. An apparatus according to claim 19, wherein the selective unit comprises:
an extracting unit extracting feature information in which a category of the A/V signal is seized; and
a comparing unit comparing the feature information with a predetermined category list, wherein the selecting unit selects the category item for the A/v signal based on a result of the comparison.

23. An apparatus according to claim 19, wherein the recording unit comprises:
a determining unit determining a compression ratio for the A/V signal according to the category item selected for the A/V signal, the recording unit recording the A/V signal, which is compressed at the compression ratio, to the storage medium.

24. An apparatus according to claim 19, wherein the category item is selected by a user.

25. An apparatus according to claim 19, further comprising:
an input unit to enable a user to add a category item.

26. An apparatus for searching a storage medium, which stores one or more audio/video (A/V) signals, for one of the A/V signals, comprising:
a display unit displaying, when a search for the A/V signal is requested, a category list of the one or more A/V signals stored in the storage medium, and, when a category item to be searched for is selected from the displayed category list, a list of the A/V signals falling under the category item; and
a reading unit reading, when the A/V signal is selected from the list of A/V signals, the selected A/V signal from the storage medium and displaying the selected A/V signal on the displaying unit.

27. A method of searching a storage medium, which stores one or more audio/video (A/V) signals, for one of the A/V signals, comprising:
displaying, when a search for the A/V signal is requested, a category item for at least one of the A/V signals stored in the storage medium and a list of at least one of the A/V signals falling under the category item; and
searching, when the A/V signal to be searched for is selected from the displayed category item and A/V signal list, the storage medium for the selected A/V signal.

28. An apparatus for searching a storage medium, which stores one or more audio/video (A/V) signals, for one of the A/V signals, comprising:
a display unit displaying, when a user inputs a category item to be searched for through a graphic user interface, a list of the one or more A/V signals falling under the category item among the one or more A/V signals stored in the storage medium; and
a searching unit searching, when the A/V signal to be searched for is selected from the displayed list of one or more A/V signals, the storage medium for the selected A/V signal.

29. A method comprising:
extracting a category item from an audio/video (A/V) signal to be recorded to a storage medium;
storing the extracted category item; and
searching for the A/V signal using the category item.

30. A method according to claim 29, wherein, the A/V signal is compressed at a compression ratio determined based on the category item of the A/V signal when recording the A/V signal to the storage medium.

31. An apparatus comprising:
an extracting unit extracting a category item from an audio/video (A/V) signal to be recorded to a storage medium;
a storing unit storing the extracted category item; and
a searching unit searching for the A/V signal using the category item.

32. An apparatus according to claim 31, wherein, the A/V signal is compressed at a compression ratio determined based on the category item of the A/V signal when recording the A/V signal to the storage medium.
